(19) United States
(12) Patent Application Publication
(10) Pub. No.: US 2009/0210147 A1
(43) Pub. Date: Aug. 20, 2009

(54) Method, Apparatus and Computer Program Product for Map Generation Using Perpendicular Projection to Merge Data

(75) Inventors: Franziskus Bauer, Koln (DE); Andre Kaufmann, Bochum (DE)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/034,016

(22) Filed: Feb. 20, 2008

(51) Int. Cl. G01C 21/04; G01C 21/00; G01C 21/30

(52) U.S. Cl. 701/206; 701/200; 701/208

(57) ABSTRACT

An apparatus for enabling generation of a map using perpendicular projection to merge data may include a processor. The processor may be configured to receive an indication of a first trace defining a first position history and a second trace defining a second position history, perform a perpendicular projection calculation with respect to portions of the first and second traces, and merge the first trace and the second trace on the basis of the perpendicular projection calculation.

### TECHNOLOGICAL FIELD

Embodiments of the present invention relate generally to map generation technology and, more particularly, relate to a method, apparatus and computer program product for merging data using perpendicular projection to enhance map generation.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users by expanding the capabilities of mobile electronic devices. One area in which there is a demand to increase ease of information transfer relates to the delivery of services to a user of a mobile terminal. The services may be in the form of a particular media or communication application desired by the user, such as a music player, a game player, an electronic book, short messages, email, content sharing, web browsing, etc. The services may also be in the form of interactive applications in which the user may respond to a network device in order to perform a task or achieve a goal. Alternatively, the network device may respond to commands or request made by the user (e.g., content searching, mapping or routing services, etc.). The services may be provided from a network server or other network device, or even from the mobile terminal such as, for example, a mobile telephone, a mobile television, a mobile gaming system, etc.

Due to the ubiquitous nature of mobile electronic devices, people of all ages and education levels are now utilizing mobile terminals to communicate with other individuals or contacts, receive services and/or to share information, media and other content. Additionally, given recent advances in processing power, battery life, the availability of peripherals such as global positioning system (GPS) receivers and the development of various applications, mobile electronic devices are increasingly used by individuals for receiving mapping or navigation services in a mobile environment. For example, cellular telephones may be equipped with GPS and may be able to provide routing services based on existing map information and GPS data indicative of the location of the cellular telephone of a user.

Despite the great utility of enabling mobile users to utilize mapping or navigation services, a common problem related to providing such services relates to the availability and/or maintenance of maps that are up to date or current. The routine maintenance, construction, and/or development of roads or other travel routes, which may experience change on a nearly continuous basis in some regions, may make it a challenging or expensive undertaking to maintain current maps upon which to base the provision of such services. Additionally, in some remote areas, the infrequency of such changes, or the lack of demand for routine updates to maps may make the updating of such maps non-viable from an economic standpoint. Thus, the provision of good service could be expensive, while a failure to update maps may result in users developing a low opinion of the service provided.

Some developments have been made aimed at enabling the users of devices with positioning capabilities to share information that can be used to update map services. In this regard, for example, TomTom Map Share™ provides a service that enables users to manually upload changes they detect to the system. Service staff may then verify the uploaded changes for use by other service users to update their maps. This type of updating requires a relatively large amount of user input insofar as the user must manually upload data and/or manually select to enable data uploaded by others to be used for updating the user's maps. Additionally, the updating of maps based on the submitted traces may be done by aggregating data on a point by point basis to merge GPS traces as described by Björn Scholz in a German thesis having a translated title “Automatic generation of street maps based on GPS traces”. However, such aggregation typically results in a merged trace having relatively low accuracy, for example, due to GPS positioning errors. Thus, a more complex merging of the traces, such as a Hough-transformation based approach, may be used to provide increased accuracy. However, Hough-transformations are typically complex and require relatively substantial computational effort.

Accordingly, it may be desirable to provide an improved mechanism by which maps may be updated that may overcome at least some of the disadvantages described above.

### BRIEF SUMMARY

A method, apparatus and computer program product are therefore provided to enable merging data using perpendicular projection to enhance map generation. In particular, a method, apparatus and computer program product are provided that may enable the receipt of trace data defining positioning information received from a particular source. The trace data may then be merged with other trace data by perpendicular projection with respect to waypoints along the traces. Accordingly, for example, a merged trace may be merged with other traces in a relatively accurate, but also relatively not complex way.

In one exemplary embodiment, a method of enabling merging data using perpendicular projection to enhance map generation is provided. The method may include receiving an indication of a first trace defining a first position history and a second trace defining a second position history, performing a perpendicular projection calculation with respect to portions of the first and second traces, and merging the first trace and the second trace on the basis of the perpendicular projection calculation.

In another exemplary embodiment, a computer program product for enabling merging data using perpendicular projection to enhance map generation is provided. The computer program product includes at least one computer-readable storage medium having computer-readable program code portions stored therein. The computer-readable program code portions include first, second and third executable portions. The first executable portion is for receiving an indication of a first trace defining a first position history and a second trace defining a second position history. The second executable portion is for performing a perpendicular projection calculation with respect to portions of the first and second traces. The third executable portion is for merging the first trace and the second trace on the basis of the perpendicular projection calculation.

In another exemplary embodiment, an apparatus for enabling merging data using perpendicular projection to enhance map generation is provided. The apparatus may include a processor. The processor may be configured to receive an indication of a first trace defining a first position history and a second trace defining a second position history, perform a perpendicular projection calculation with respect to portions of the first and second traces, and merge the first trace and the second trace on the basis of the perpendicular projection calculation.

In another exemplary embodiment, an apparatus for enabling merging data using perpendicular projection to enhance map generation is provided. The apparatus includes means for receiving an indication of a first trace defining a first position history and a second trace defining a second position history, means for performing a perpendicular projection calculation with respect to portions of the first and second traces, and means for merging the first trace and the second trace on the basis of the perpendicular projection calculation.

Embodiments of the invention may provide a method, apparatus and computer program product for employment in mobile environments in which mapping or routing services are provided. As a result, for example, mobile terminal users may enjoy an improved mapping or routing service on the basis of maps that are updated using information provided automatically by other mobile terminal users.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 illustrates a block diagram of an apparatus for enabling map updating using perpendicular projection to merge data according to an exemplary embodiment of the present invention;

FIG. 4 illustrates a block diagram of portions of a system for enabling map generation using perpendicular projection to merge trace data according to an exemplary embodiment of the present invention;

FIG. 5 illustrates an example of perpendicular projection calculation according to an exemplary embodiment of the present invention;

FIG. 6 illustrates another example of perpendicular projection calculation according to an exemplary embodiment of the present invention; and

FIG. 7 is a flowchart according to an exemplary method for enabling map updating using perpendicular projection to merge data according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

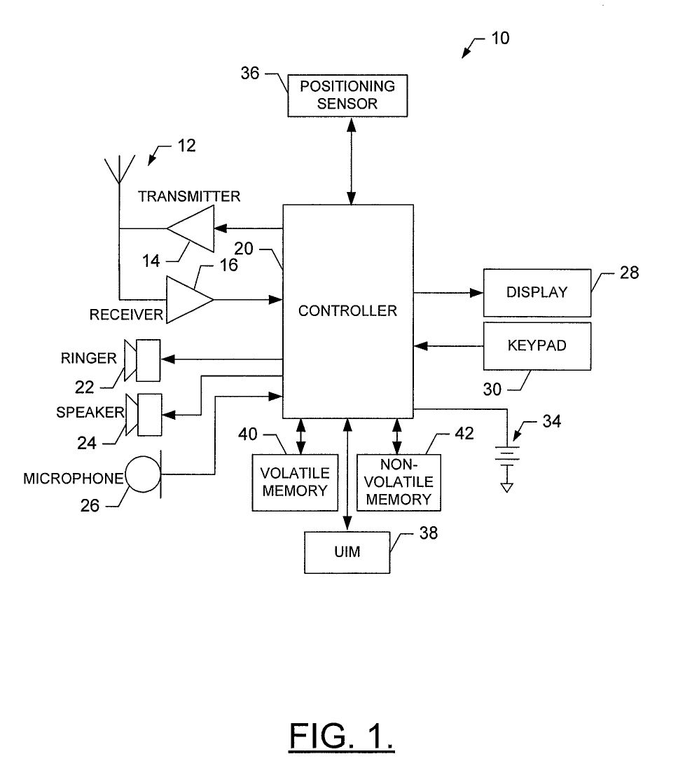

FIG. 1, one aspect of the invention, illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While several embodiments of the mobile terminal 10 are illustrated and will be hereinafter described for purposes of example, other types of mobile terminals, such as portable digital assistants (PDAs), pagers, mobile televisions, gaming devices, laptop computers, cameras, video recorders, audio/video player, radio, GPS devices, or any combination of the aforementioned, and other types of voice and text communications systems, can readily employ embodiments of the present invention.

In addition, while several embodiments of the method of the present invention are performed or used by a mobile terminal 10, the method may be employed by other than a mobile terminal. Moreover, the system and method of embodiments of the present invention will be primarily described in conjunction with mobile communications applications. It should be understood, however, that the system and method of embodiments of the present invention can be utilized in conjunction with a variety of other applications, both in the mobile communications industries and outside of the mobile communications industries.

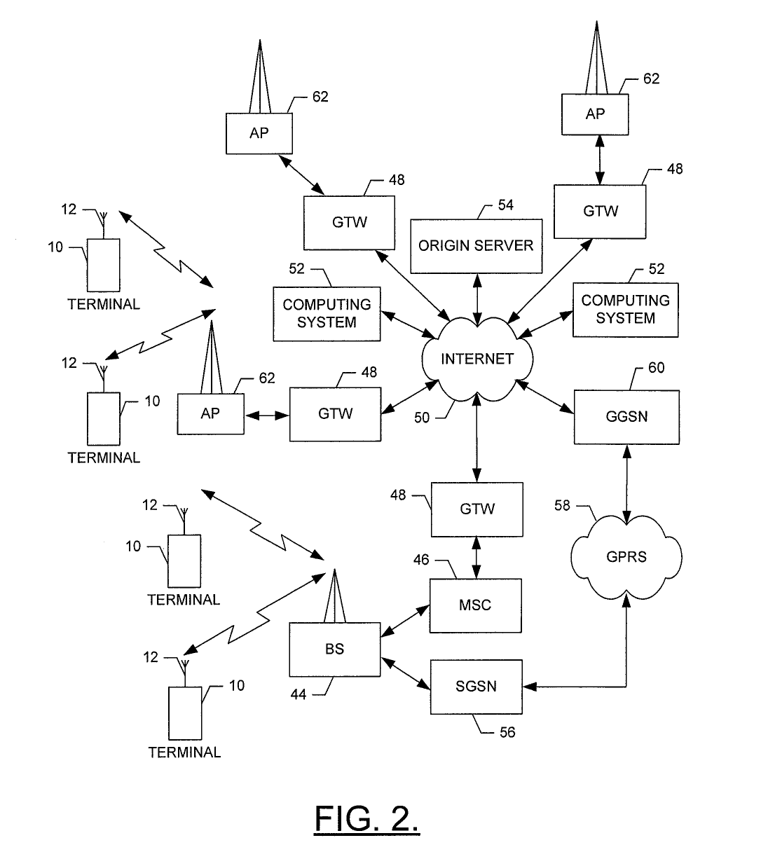

The mobile terminal 10 may include an antenna 12 (or multiple antennae) in operable communication with a transmitter 14 and a receiver 16. The mobile terminal 10 may further include an apparatus, such as a controller 20 or other processing element, that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks described below in connection with FIG. 2.

It is understood that the apparatus, such as the controller 20, may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In addition, the mobile terminal 10 may include a positioning sensor 36. The positioning sensor 36 may include, for example, a global positioning system (GPS) sensor, an assisted global positioning system (Assisted-GPS) sensor, a Bluetooth (BT)-GPS mouse, other GPS or positioning receivers or the like. However, in one exemplary embodiment, the positioning sensor 36 may include a pedometer or inertial sensor. In this regard, the positioning sensor 36 may be capable of determining a location of the mobile terminal 10, such as, for example, longitudinal and latitudinal directions of the mobile terminal 10, or a position relative to a reference point such as a destination or start point. Information from the positioning sensor 36 may then be communicated to a memory of the mobile terminal 10 or to another memory device to be stored as a position history or location information. In this regard, for example, the position history may define a series of data points corresponding to positions of the mobile terminal 10 at respective times. The position history may be referred to as a “trace”. The trace may further include one or more segments each of which defines a position history or route between two waypoints. In many instances, the segments may be substantially linear. However, segments could also be curvilinear to some degree.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10. Furthermore, the memories may store instructions for determining cell id information. Specifically, the memories may store an application program for execution by the controller 20, which determines an identity of the current cell, i.e., cell id identity or cell id information, with which the mobile terminal 10 is in communication. In conjunction with the positioning sensor 36, the cell id information may be used to more accurately determine a location of the mobile terminal 10.

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 (two shown in FIG. 2), origin server 54 (one shown in FIG. 2) or the like, as described below.

The BS 44 can also be coupled to a serving GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a gateway GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 and/or origin server 54 may be coupled to the mobile terminal 10 via the Internet 50, SGSN 56 and GGSN 60. In this regard, devices such as the computing system 52 and/or origin server 54 may communicate with the mobile terminal 10 across the SGSN 56, GPRS core network 58 and the GGSN 60. By directly or indirectly connecting mobile terminals 10 and the other devices (e.g., computing system 52, origin server 54, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (IG), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, the origin server 54, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

Although not shown in FIG. 2, in addition to or in lieu of coupling the mobile terminal 10 to computing systems 52 across the Internet 50, the mobile terminal 10 and computing system 52 may be coupled to one another and communicate in accordance with, for example, RF, BT, IrDA or any of a number of different wireline or wireless communication techniques, including LAN, WLAN, WiMAX, UWB techniques and/or the like. One or more of the computing systems 52 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing systems 52, the mobile terminal 10 may be configured to communicate with the portable electronic devices in accordance with techniques such as, for example, RF, BT, IrDA or any of a number of different wireline or wireless communication techniques, including universal serial bus (USB), LAN, WLAN, WiMAX, UWB techniques and/or the like.

In an exemplary embodiment, content or data may be communicated over the system of FIG. 2 between a mobile terminal, which may be similar to the mobile terminal 10 of FIG. 1, and a network device of the system of FIG. 2 in order to, for example, execute applications or establish communication (for example, for purposes of content sharing) between the mobile terminal 10 and other mobile terminals. As such, it should be understood that the system of FIG. 2 need not be employed for communication between mobile terminals or between a network device and the mobile terminal, but rather FIG. 2 is merely provided for purposes of example. Furthermore, it should be understood that embodiments of the present invention may be resident on a communication device such as the mobile terminal 10, and/or may be resident on a camera, server, personal computer or other device, absent any communication with the system of FIG. 2.

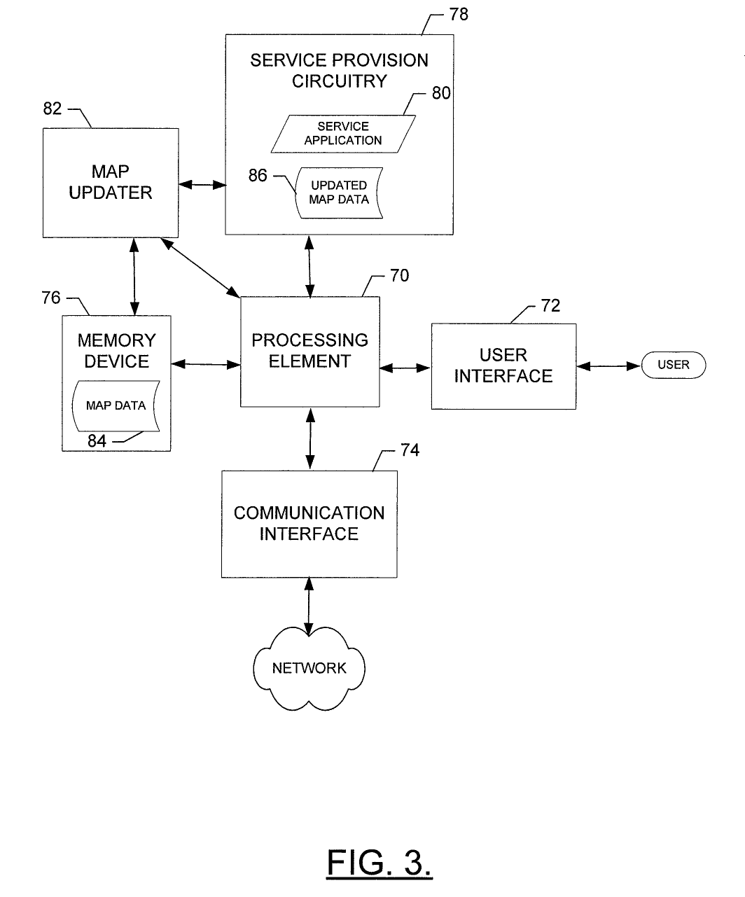

An exemplary embodiment of the invention will now be described with reference to FIG. 3, in which certain elements of an apparatus for enabling map updating using perpendicular projection to merge data are displayed. The apparatus of FIG. 3 may be embodied as or otherwise employed, for example, on a network device such as a server of FIG. 2. However, it should be noted that the system of FIG. 3, may also be employed on a variety of other devices, both mobile (e.g., the mobile terminal 10) and fixed, and therefore, the present invention should not be limited to application on devices such as servers. It should also be noted that while FIG. 3 illustrates one example of a configuration of an apparatus for enabling map updating using perpendicular projection to merge data, numerous other configurations may also be used to implement embodiments of the present invention.

Referring now to FIG. 3, an apparatus for enabling map updating using perpendicular projection to merge data is provided. The apparatus may include or otherwise be in communication with a processing element 70, a user interface 72, a communication interface 74 and a memory device 76. The memory device 76 may include, for example, volatile and/or non-volatile memory (e.g., volatile memory 40 and/or non-volatile memory 42). The memory device 76 may be configured to store information, data, applications, instructions or the like for enabling the apparatus to carry out various functions in accordance with exemplary embodiments of the present invention. For example, the memory device 76 could be configured to buffer input data for processing by the processing element 70. Additionally or alternatively, the memory device 76 could be configured to store instructions for execution by the processing element 70. As yet another alternative, the memory device 76 may be one of a plurality of databases that store information in the form of static and/or dynamic information, for example, in association with a particular location, event or service point.

The processing element 70 may be embodied in a number of different ways. For example, the processing element 70 may be embodied as a processor, a coprocessor, a controller or various other processing means or devices including integrated circuits such as, for example, an ASIC (application specific integrated circuit) or FPGA (field programmable gate array). In an exemplary embodiment, the processing element 70 may be configured to execute instructions stored in the memory device 76 or otherwise accessible to the processing element 70. Meanwhile, the communication interface 74 may be embodied as any device or means embodied in either hardware, software, or a combination of hardware and software that is configured to receive and/or transmit data from/to a network and/or any other device or module in communication with the apparatus. In this regard, the communication interface 74 may include, for example, an antenna and supporting hardware and/or software for enabling communications with a wireless communication network.

The user interface 72 may be in communication with the processing element 70 to receive an indication of a user input at the user interface 72 and/or to provide an audible, visual, mechanical or other output to the user. As such, the user interface 72 may include, for example, a keyboard, a mouse, a joystick, a touch screen display, a conventional display, a microphone, a speaker, or other input/output mechanisms. In an exemplary embodiment in which the apparatus is embodied as a server, the user interface 72 may be limited, or even eliminated.

In an exemplary embodiment, the processing element 70 may be embodied as or otherwise control service provision circuitry 78. In this regard, for example, the service provision circuitry 78 may include structure for executing a service application 80. The service application 80 may be an application including instructions for execution of various functions in association with embodiments of the present invention. In an exemplary embodiment, the service application 80 may include or otherwise communicate with applications and/or circuitry for providing a mapping service. The mapping service may further include routing services and/or directory or look-up services related to particular service point (e.g., business, venue, party or event location, address, site or other entity related to a particular geographic location and/or event). As such, according to an exemplary embodiment, the processing element 70 (for example, via a map updater 82) may be configured to enable map updating using perpendicular projection to merge data as will be described in greater detail below.

In an exemplary embodiment, the processing element 70 may also be embodied as or otherwise control the map updater 82. The map updater 82 may be any means or device embodied in hardware, software, or a combination of hardware and software that is configured to provide map updating based on received trace information from various sources. In this regard, for example, the map updater 82 may be configured to receive data from a mobile terminal defining a trace representative of a position history of the mobile terminal. The map updater 82 may be configured to merge the received trace data with other or existing trace data as described in greater detail below. The merging of trace data may verify existing map data (e.g., verifying a position of an existing road) or be used to update existing map data (e.g., by indicating a new road or route). In this regard, for example, the map updater 82 may receive information (e.g., from the memory device 76) defining map data 84 that may be pre-existing from any source. The map data 84 may define various different roads, routes, paths, or the like. In some cases the map data 84 may further include information such as terrain features, construction features, points of interest, or other map features. Data defining a road, route, path or the like may include segments and waypoints as described above. As such, the data defining a particular road, route, path, etc., may be considered an existing trace. However, a trace could alternatively only refer to position data received from a mobile terminal. Each subsequently received trace may also be merged with other or existing data to maintain a continuous, routine or periodic updating of the map data based on incoming traces. The other trace data may be trace data received from another mobile terminal (or at another time from the same or another mobile terminal) that corresponds to a currently received trace, for example, within a threshold amount.

The merging of received trace data with existing or other trace data may be used to update the map data 84 to define updated map data 86. The updated map data 86, which may be stored in the memory device 76 also, may be provided by the map updater 82 to the service provision circuitry 78 for use by the service application 80 in connection with providing mapping or routing services based on the updated map data 86. As such, the map updater 82 may generate the updated map data 86 based on the map data 84 and/or received trace data from one or more sources (e.g., mobile terminals).

In an exemplary embodiment, the map data 84 may initially represent a map acquired or purchased from an existing map vendor or otherwise generated based on data gathered (or updated) at a particular point in time. Meanwhile, the updated map data 86 may represent map data that is generated subsequent to an incorporation of user data (e.g., real life trace data) received from one or more mobile users. As such, the updated map data 86 may incorporate actual data supplied by travelers and indicative of the routes traveled by the respective travelers. In some cases the map data 84 may itself include updated data. As such, the term “map data” may not necessarily imply that the map data has never been updated. Rather, the term “map data” should be understood to imply that there may be a more recently updated version (e.g., the updated map data 86).

In an exemplary embodiment, the trace data may be reported from users (e.g., users of the mobile terminal 10) on a continuous, periodic or routine basis. For example, in some embodiments, a mobile terminal may communicate trace information to the apparatus of FIG. 3 at predetermined intervals or in response to predetermined events (e.g., events requiring location based services). Accordingly, at the predetermined interval or in response to an occurrence of the predetermined event, the mobile terminal may upload trace information including trace data for one or more travel segments to the apparatus. As yet another alternative, a mobile terminal may report a continuous or near continuous stream of position information to the apparatus in a real-time or nearly real-time manner. Combinations of the above described mechanisms, or operation in accordance with selectable modes defining one or more of the above or other possible mechanisms may also be employed.

Although in some embodiments, the user may be prompted to release trace data to the apparatus or the trace data may only be received by the apparatus in response to the user voluntarily sending such data to the apparatus via an overt action, the trace data may also be acquired automatically. For example, participants in a service (e.g., a mapping or routing service) may consent to sharing their information under all or predetermined circumstances for the common good of other users in updating the map data 84. As another alternative, users may enable or disable trace reporting functions and, when such functions are enabled, the reporting of trace data to the apparatus may be performed from the mobile terminal 10 of the respective user who enabled such functionality without further user interaction. Accordingly, data for updating map data may be acquired without significant (or in some circumstances any) user interaction. In some instances, a user may provide a profile during registration for a service associated with providing map updates. The profile may define the timing of and/or circumstances under which the user's respective terminal reports trace data to the apparatus. Accordingly, reporting of trace data to the apparatus may be accomplished without additional user interaction at the time such reports are made.

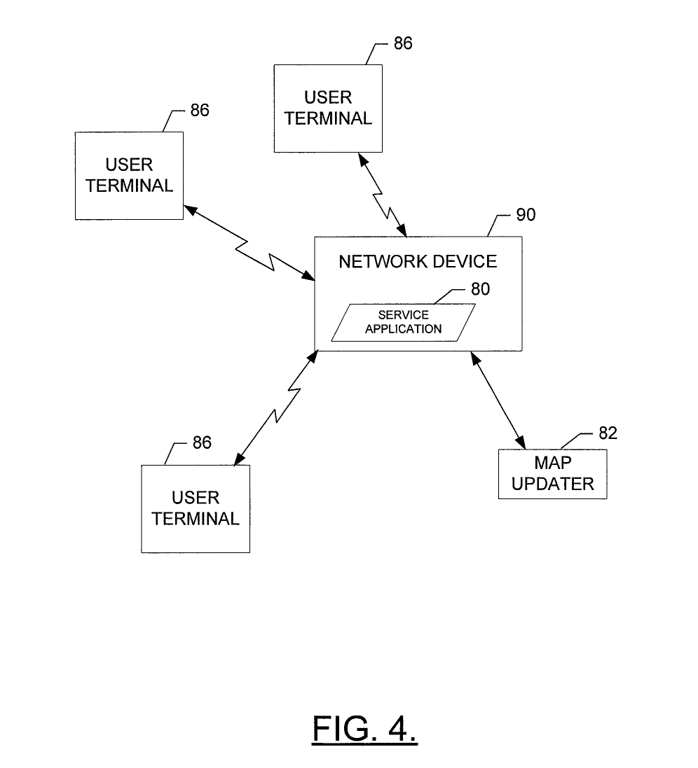

FIG. 4 illustrates an embodiment of the present invention in which certain elements of a system for enabling map generation using perpendicular projection to merge trace data are displayed. The system of FIG. 4 may be employed in connection with the mobile terminal 10 of FIG. 1 (or a plurality of mobile terminals) and/or the network illustrated in reference to FIG. 2. However, although FIG. 4 illustrates an embodiment of the present invention being practiced in connection with a network device 90 (e.g., a server) that coordinates functionality associated with practicing embodiments of the invention in combination with other devices, it should be noted that the system of FIG. 4 may also be employed on a variety of other devices, both mobile and fixed, and therefore, the present invention should not be limited to application on devices such as servers or in combination with the specific devices illustrated in FIG. 4. As such, it should be appreciated that while FIG. 4 illustrates one example of a configuration of a system for enabling map generation using perpendicular projection to merge trace data, numerous other configurations may also be used to implement embodiments of the present invention. Accordingly, the devices or elements described below may not be mandatory and thus some may be omitted in certain embodiments. Moreover, embodiments of the present invention need not be practiced at a single device, but rather combinations of devices may collaborate to perform embodiments of the present invention.

Referring now to FIG. 4, a system for enabling map generation using perpendicular projection to merge trace data is provided. The system may include the network device 90 (e.g., the apparatus of FIG. 3), which may be in communication with one or more user terminals 92 (e.g., via the system of FIG. 2), each of which may be any of the exemplary mobile terminal devices described in connection with the description of FIG. 1 (e.g., a GPS device or GPS enabled mobile phone, etc.). The network node 90, which may execute the service application 80, may utilize the map updater 82 to merge trace data received from each of the user terminals 92 with existing or other trace data to provide map updating so that mapping and/or routing services may be provided on the basis of updated map data. The map updater 82 may be collocated with or a component of the network device 90. However, as an alternative, the map updater 82 may be located at another device in communication with the network device 90 as shown, for example, in FIG. 4.

As indicated above, the reporting or provision of trace data from the various user terminals 92 may be provided in an automatic (or semi-automatic) fashion. As such, the updating of the map data, and thus map generation, may be automatically (or semi-automatically) performed. In this regard, for example, existing maps may be updated to define new roads, detours, paths, etc. and/or new maps may be produced (e.g., for emerging markets) based on trace data indicative of routes, paths, roads, etc., that have been traveled by individuals carrying user terminals 92. In either case, whether an existing map is generated or a new map is generated, map generation based on merging trace data may be considered an enabling factor with respect to the maps generated. The map updater 82 may be configured to perform updates at any desirable stimulus. For example, the map updater 82 may be configured to perform updates in response to receipt of a new trace, in response to other predefined events, or in response to passage of a predetermined time period since the last update.

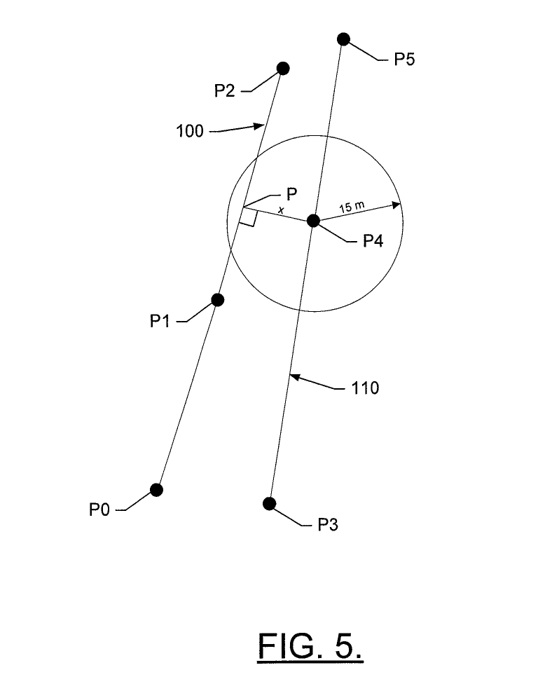

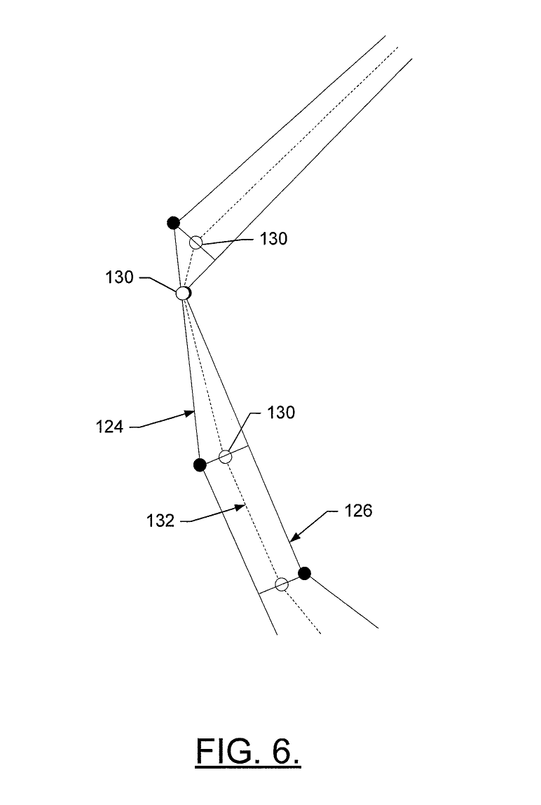

A more detailed description of the operation of the map updater 82 will now be described in reference to FIGS. 5 and 6, which illustrate examples of perpendicular projection calculations in accordance with exemplary embodiments of the present invention. In this regard, FIG. 5 illustrates two exemplary traces that may be merged in accordance with an exemplary embodiment of the present invention. As shown in FIG. 5, a first trace 100 may be received at a first time and may define a history of positions for a particular mobile terminal over a particular period of time. The first trace 100 may include three waypoints (e.g., waypoint one P0, waypoint two P1, and waypoint three P2), the order of which may correspond to the respective time sequence at which such waypoints were encountered. At a different time (or from a different mobile terminal) a second trace 110 may be received. The second trace 110 may correspond to a history of positions for another (or the same) mobile terminal at another particular period of time. The second trace 110 may also include three waypoints (e.g., waypoint one P3, waypoint two P4, and waypoint three P5), the order of which may correspond to the respective time sequence at which such waypoints were encountered. Although the first and second traces 100 and 110 are continuous in FIG. 5, traces need not be continuous for merging since individual segments may be merged. Furthermore, a trace may be defined from position history data that includes interpolated movement between sequential position reports. Accordingly, even if a device is taken into a tunnel or another location where position cannot be reported, movement between two reported positions may be ignored (e.g., no segment may be provided between the positions) or movement between the positions may be interpolated (e.g., a segment may be defined between the two reported positions with the assumption of straight travel therebetween).

A description of a merging operation with respect to the first and second traces 100 and 10 will now be described in the context of the first and second traces 100 and 110 representing the only two traces received for the corresponding region in which the traces may lie. However, it should be understood that one of the first and second traces 100 and 110 (e.g., the first trace 100) may alternatively represent a composite trace generated from a plurality of previously received traces. In this regard, the composite trace may be generated by merging a series of traces or intermediate composite traces with a prior newly received trace when the prior newly received trace was received. As such, for example, each time a new trace is received, the new trace (e.g., the second trace 110) may be merged with a composite trace (e.g., the first trace 100) that was previously generated by the sequential merging of each previously received trace (which at the time of receipt corresponded to the second trace 110 for a previous merge operation) with an intermediate composite trace (which at the time of receipt of the second trace 110 corresponded to the first trace 100 of the previous merge operation) generated based on all traces received prior thereto. As yet another alternative, one of the traces may correspond to a map route, road, path, etc. for an existing map to be updated.

In an exemplary embodiment, the merging of the first and second traces 100 and 110 may be accomplished by perpendicular projection of one trace on a linear interpolation of the other. In order to merge traces, a determination may initially be made with respect to whether or not the traces include common segments. For example, if a certain segment of a trace is within a threshold distance of a segment of another trace, the segments may be assumed to be common segments, which may be merged. GPS and other position determining mechanisms typically have errors associated therewith. Accordingly, two individuals traveling down the exact same road may record and thereafter report traces defining their respective position histories over the road in respective traces that are not identical. The difference between the reported traces may be at least in part attributable to differences in the accuracy associated with the respective position determining mechanisms associated with each of the individuals. However, the differences could also be due to the fact that slightly different paths were used by the individuals over the segments.

In a conventional merge operation, a waypoint to waypoint comparison may be used to determine whether a particular segment in one trace corresponds to a segment in another trace. As such, for example, a threshold value (e.g., a value defined in yards, feet or meters) may be used as a boundary for excluding segments from merging operation. Thus, according to one example where the threshold is 15 meters, if waypoint P1 of the first trace 100 is within 15 meters of waypoint P4 of the second trace 110 and waypoint P2 of the first trace 100 is within 15 meters of waypoint P5 of the second trace 110, the respective segments defined between the waypoints of each respective trace may be merged. However, as indicated in FIG. 5, although waypoints P2 and P5 are within 15 meters of each other, waypoints P1 and P4 are not within 15 m of each other and thus the merge operation would likely not be performed.

Embodiments of the present invention consider that the traces may still correspond to each other if the traces are within a threshold distance of one another even if specific waypoints are not. Accordingly, embodiments of the present invention utilize perpendicular projection to determine which segments may be merged. As shown in FIG. 5, a point P along the first trace 100 that is perpendicular to the waypoint P4 of the second trace 110 (with respect to the trajectory of the first trace 100) is less than 15 meters apart. Accordingly, embodiments of the present invention may utilize more waypoints for merging than a conventional point to point merging mechanism may utilize. In this regard, in many situations it is possible, or even probable, that a point on a neighboring trace (e.g., point P) is closer to an actual waypoint (e.g., waypoint P4), than all other waypoints of the opposite segment. In fact, in some situations (like that illustrated in FIG. 5) it may even be clear that the perpendicular distance between waypoint P4 is under the threshold, while the distance between waypoints P1 and P4 is not.

In general, perpendicular projection may be employed for determining distances between traces by utilizing a perpendicular calculation to calculate not only the min_distance (minimum distance) to a neighbor waypoint, but also the pre- and successor ([index−1] and [index+1]) of such distance. As such, it may be possible to calculate the real minimum distance to a line, by using the formula displayed below in equation (1).

[P₃−P₁−x*(P₂−P₁)]·(P₂−P₁)=0

P=P₁+x*(P₂−P₁) (1)

By calculating the ‘x’ value in equation (1), for which the dot product becomes zero, a line from a particular point (e.g., waypoint P4) to the other trace (e.g., the first trace 110) and perpendicular to the second trace 110 may be determined. The length of this perpendicular line may be equivalent to the minimum distance between a point of one trace and the line of the other trace. Having calculated the perpendicular distance, a determination may be made regarding which segments or parts of segments are below the threshold and can therefore be used in merging calculations. Each time a minimum distance is found using the perpendicular calculation described above, the determined perpendicular (or minimum) distance may be used to determine whether the corresponding waypoint and/or segment can be used for merging. In this regard, if the minimum distance between a waypoint and a point perpendicular to the waypoint with respect to the extension of the compared segment is less than the threshold, then the corresponding waypoint may be used for merging operations. Although the measurements above are described with respect to a waypoint, it should be understood that any point along a particular trace could be treated as a waypoint.

In an exemplary embodiment, as described above, a new trace may be merged with previously approved map data or a composite trace. Accordingly, to ensure the new trace does not skew previously determined data that may be reliable, a weighting scheme may be employed. In this regard, for example, composite traces or existing and/or previously verified map data may be weighted higher than a new trace. Accordingly, weighted traces may be given priority based on a level of confidence that may be associated with such traces. The amount of weight could depend on a variety of factors. For example, a weight value for an existing trace or composite trace may decrease with age or increase with each additional or incremental merging operation. As such, a composite trace developed from ten merge operations may carry greater weight than a composite trace developed from two merge operations. In some embodiments, a trace quality may be determined for each trace based on a magnitude of the perpendicular distance determined for segments merged. In other words, a shorter perpendicular distance may correspond to a higher trace quality. Subsequent to each merge operation, the composite quality of the composite trace may be updated based on the constituent qualities of the traces merged to form the composite trace. Thus, for example, a segment of a map, where several traces have been merged previously to generate the composite segment will have a higher weight than any new trace.

FIG. 6 shows an exemplary merging operation between two separate traces (e.g., trace 124 and trace 126). In an exemplary embodiment, when merging two segments that each have equal weight, an algorithm may calculate a middle point 130 of each perpendicular line determined along the two corresponding traces (e.g., determined according to perpendicular projection). The middle point 130 (or sequence of middle points) may be stored as merged data (e.g., in a corresponding merged-list). Information regarding the middle points relative to selected points in the two segments (e.g., waypoints) may be used to generate a merged segment (or composite trace 132) by connecting consecutive middle points as shown in FIG. 6. As such, the middle points 130 of FIG. 6 represent a half way point between a particular point on one trace (e.g., a waypoint) and a point that is a minimum distance from the particular point on the other trace. By merging traces in this manner, a higher amount of waypoints may be utilized to form a merge list defining merged trace data (e.g., for defining data of the updated map data 86) compared to point by point merging. As a result, for example, the merged data (e.g., composite trace or combined curves) may be relatively more realistic.

Merging of traces without equal weights may be accomplished in consideration of the relative weights of the traces being merged. Numerous mechanisms could be employed for such merging. For example, the mechanism described above in relation to FIG. 6 could be employed except that instead of finding a middle point along the perpendicular line determined by perpendicular projection, the point defined between the traces may be offset from the higher weighed in proportion to the ratio of the lower weight to the higher weight. As such, for example, if one trace has a weight of 10 and the other trace has a weight of 1, the point defined between the traces along the perpendicular line may be offset from the higher weighted trace by 1/10^{th} of the distance defined by the line. A series of such points may then be connected to define the merged trace.

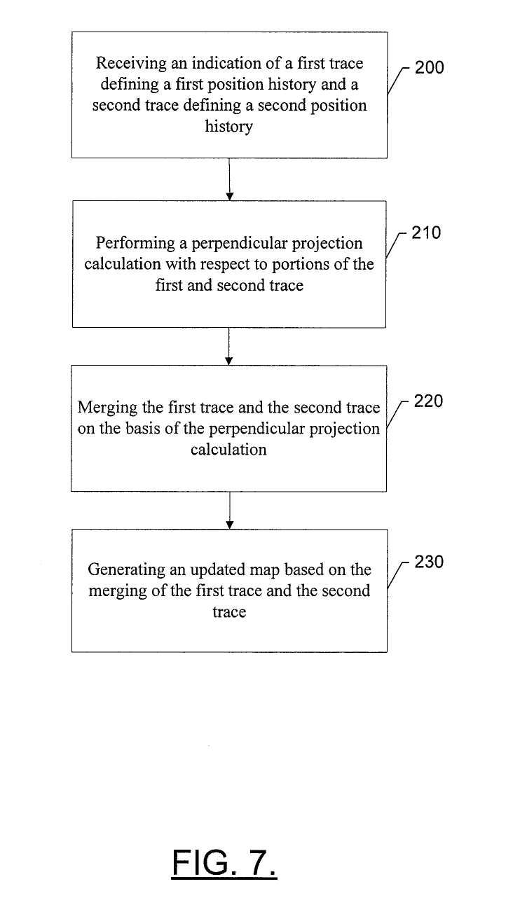

FIG. 7 is a flowchart of a system, method and program product according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described above may be embodied by computer program instructions. In this regard, the computer program instructions which embody the procedures described above may be stored by a memory device of the mobile terminal or network device and executed by a built-in processor in the mobile terminal or network device. As will be appreciated, any such computer program instructions may be loaded onto a computer or other programmable apparatus (i.e., hardware) to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

In this regard, one embodiment of a method for enabling merging data using perpendicular projection as illustrated, for example, in FIG. 7 may include receiving an indication of a first trace defining a first position history and a second trace defining a second position history at operation 200. The method may further include performing a perpendicular projection calculation with respect to portions of the first and second traces at operation 210. At operation 220, the first trace and the second trace may be merged on the basis of the perpendicular projection calculation. In an exemplary embodiment, an alternative method may include generating an updated map based on the merging of the first trace and the second trace at operation 230.

In an exemplary embodiment, operation 220 may include merging the first trace and the second trace in consideration of a weighting factor applied to at least one of the first trace and the second trace. As an alternative or additionally, operation 220 may include merging the first trace comprising a composite trace generated on the basis of merging a plurality of previously received traces with the second trace comprising a recently received trace. In some embodiments, if the first trace and the second trace each have equal weighting factors, operation 220 may include generating a composite trace defined by connecting sequential mid points along each perpendicular line generated for each respective waypoint. Additionally, in some embodiments, operation 220 may include merging portions of the first trace with corresponding portions of the second trace that are determined to be within a predetermined distance from each other based on the perpendicular projection calculation.

In an exemplary embodiment, operation 210 may include, for at least one waypoint of the first trace or the second trace, determining a minimum distance from the waypoint to a point on the other trace. The determination of the minimum distance may include determining a length of a perpendicular line extending from the point in a direction perpendicular to the trace on which the point is disposed to the waypoint.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
receiving an indication of a first trace defining a first position history and a second trace defining a second position history;
performing a perpendicular projection calculation with respect to portions of the first and second traces; and
merging the first trace and the second trace on the basis of the perpendicular projection calculation.

2. A method according to claim 1, wherein merging the first trace and the second trace comprises merging the first trace and the second trace in consideration of a weighting factor applied to at least one of the first trace and the second trace.

3. A method according to claim 2, wherein merging the first trace and the second trace comprises merging the first trace comprising a composite trace generated on the basis of merging a plurality of previously received traces with the second trace comprising a more recently received trace.

4. A method according to claim 1, wherein performing the perpendicular projection calculation comprises, for at least one waypoint of the first trace or the second trace, determining a minimum distance from the waypoint to a point on the other trace.

5. A method according to claim 4, wherein determining the minimum distance comprises determining a length of a perpendicular line extending from the point in a direction perpendicular to the trace on which the point is disposed to the waypoint.

6. A method according to claim 5, wherein, if the first trace and the second trace each have equal weighting factors, merging the first trace and the second trace comprises generating a composite trace defined by connecting sequential mid points along each perpendicular line generated for each respective waypoint.

7. A method according to claim 1, wherein merging the first trace and the second trace comprises merging portions of the first trace with corresponding portions of the second trace that are determined to be within a predetermined distance from each other based on the perpendicular projection calculation.

8. A method according to claim 1, further comprising generating an updated map based on the merging of the first trace and the second trace.

9. A computer program product comprising at least one computer-readable storage medium having computer-readable program code portions stored therein, the computer-readable program code portions comprising:
a first executable portion for receiving an indication of a first trace defining a first position history and a second trace defining a second position history;
a second executable portion for performing a perpendicular projection calculation with respect to portions of the first and second traces; and
a third executable portion for merging the first trace and the second trace on the basis of the perpendicular projection calculation.

10. A computer program product according to claim 9, wherein the third executable portion includes instructions for merging the first trace and the second trace in consideration of a weighting factor applied to at least one of the first trace and the second trace.

11. A computer program product according to claim 10, wherein the third executable portion includes instructions for merging the first trace comprising a composite trace generated on the basis of merging a plurality of previously received traces with the second trace comprising a more recently received trace.

12. A computer program product according to claim 9, wherein the second executable portion includes instructions for determining, for at least one waypoint of the first trace or the second trace, a minimum distance from the waypoint to a point on the other trace.

13. A computer program product according to claim 12, wherein the second executable portion includes instructions for determining a length of a perpendicular line extending from the point in a direction perpendicular to the trace on which the point is disposed to the waypoint.

14. A computer program product according to claim 13, wherein the third executable portion includes instructions for, if the first trace and the second trace each have equal weighting factors, generating a composite trace defined by connecting sequential mid points along each perpendicular line generated for each respective waypoint.

15. A computer program product according to claim 9, wherein the third executable portion includes instructions for merging portions of the first trace with corresponding portions of the second trace that are determined to be within a predetermined distance from each other based on the perpendicular projection calculation.

16. A computer program product according to claim 9, further comprising a fourth executable portion for generating an updated map based on the merging of the first trace and the second trace.

17. An apparatus comprising a processor configured to:
receive an indication of a first trace defining a first position history and a second trace defining a second position history;
perform a perpendicular projection calculation with respect to portions of the first and second traces; and
merge the first trace and the second trace on the basis of the perpendicular projection calculation.

18. An apparatus according to claim 17, wherein the processor is configured to merge the first trace and the second trace by merging the first trace and the second trace in consideration of a weighting factor applied to at least one of the first trace and the second trace.

19. An apparatus according to claim 18, wherein the processor is configured to merge the first trace and the second trace by merging the first trace comprising a composite trace generated on the basis of merging a plurality of previously received traces with the second trace comprising a more recently received trace.

20. An apparatus according to claim 17, wherein the processor is configured to perform the perpendicular projection calculation by, for at least one waypoint of the first trace or the second trace, determining a minimum distance from the waypoint to a point on the other trace.

21. An apparatus according to claim 20, wherein the processor is configured to determine the minimum distance by determining a length of a perpendicular line extending from the point in a direction perpendicular to the trace on which the point is disposed to the waypoint.

22. An apparatus according to claim 21, wherein the processor is configured to merge the first trace and the second trace by generating a composite trace defined by connecting sequential mid points along each perpendicular line generated for each respective waypoint, if the first trace and the second trace each have equal weighting factors.

23. An apparatus according to claim 17, wherein the processor is configured to merge the first trace and the second trace by merging portions of the first trace with corresponding portions of the second trace that are determined to be within a predetermined distance from each other based on the perpendicular projection calculation.

24. An apparatus according to claim 17, wherein the processor is further configured to generate an updated map based on the merging of the first trace and the second trace.

25. An apparatus comprising:
means for receiving an indication of a first trace defining a first position history and a second trace defining a second position history;
means for performing a perpendicular projection calculation with respect to portions of the first and second traces; and
means for merging the first trace and the second trace on the basis of the perpendicular projection calculation.

26. A method comprising:
receiving an indication of a first trace defining a first position history and a second trace defining a second position history, wherein the first and second traces each comprise a respective sequence of waypoints;
determining if portions of the first and second traces are within a predefined distance of one another, wherein the portion of at least one of the first and second traces is between and fails to include a waypoint; and
merging the first trace and the second trace on the basis of the determination.
